(19) United States
(12) Patent Application Publication
(10) Pub. No.: US 2012/0011014 A1
(43) Pub. Date: Jan. 12, 2012

(54) MEDIA PURCHASE TECHNIQUES

(75) Inventors: Scott D. Stacey, Seattle, WA (US); Praveen Kumar Vemparala, Redmond, WA (US); Geir O. Martinsen, Seattle, WA (US); Robert N. Pulliam, JR., Seattle, WA (US); Uchechukwu U. Adegbite, San Francisco, CA (US); Mark D. Schwesinger, Bellevue, WA (US); August W. Hill, Redmond, WA (US); Zachariah G. Johnson, Woodinville, WA (US)

(73) Assignee: MICROSOFT CORPORATION, Redmond, WA (US)

(21) Appl. No.: 12/875,509

(22) Filed: Sep. 3, 2010

Related U.S. Application Data
(60) Provisional application No. 61/362,574, filed on Jul. 8, 2010.

(51) Int. Cl. G06Q 30/00; G06F 21/00; G06F 15/16; G06F 3/00

(52) U.S. Cl. 705/26.1; 715/704; 726/28; 709/231

(57) ABSTRACT

Media purchase techniques are described. In an implementation, an indication is received that an item of media was successfully purchased through a single transaction that includes rights for access to the item of media in different forms that are optimized, respectively, for different classes of computing devices. Responsive to the receipt of the indication, the item of media is permitted to be streamed to at least one of the computing devices to enable output of the item of media for playback as the item of media is streamed and storage of the item of media to local storage of the computing device.

### RELATED APPLICATIONS

This application claims priority under 35 U.S.C. Section 119(e) to U.S. Provisional Patent Application No. 61/362,574, filed on Jul. 8, 2010 and titled “Media Purchase Techniques,” the entire disclosure of which is hereby incorporated by reference.

### BACKGROUND

Computing devices may include a vast amount of media. For example, a user may interact with a computer to access websites to purchase and download music, movies, “audio books,” and so on. Through this and other interaction, a user may use the computer to compile thousands of items of media for later playback. For instance, it is not uncommon for users to store thousands and even tens of thousands of songs on the computer.

A user may also interact with a wide variety of computing devices in a typical day, such as a mobile communications device (e.g., wireless phone), game console, desktop PC, and so on. However, traditional techniques that were utilized to interact with media were often device centric and thus limited interaction with particular media to particular devices.

### SUMMARY

Media purchase techniques are described. In an implementation, an indication is received that an item of media was successfully purchased through a single transaction that includes rights for access to the item of media in different forms that are optimized, respectively, for different classes of computing devices. Responsive to the receipt of the indication, the item of media is permitted to be streamed to at least one of the computing devices to enable output of the item of media for playback as the item of media is streamed and storage of the item of media to local storage of the computing device.

In an implementation, an item of media is offered for purchase via a network in which a single purchase of the item of media is configured to permit access to the item of media using a plurality of computing devices and permit access to the item of media as being optimized for a computer class, a mobile class, and a television class of computing device. Access to the item of media as optimized is provided responsive to verification of successive processing of purchase information to purchase the item of media.

In an implementation, a listing is received at a computing device that references one or more items of media purchased from a media provider via a user account that are available for communication to the computing device after logging in to the user account. Responsive to selection of at least one item of media, the item of media is received in a form that is optimized for the computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ media techniques described herein.

FIG. 2 is an illustration of a system in an example implementation in which a media manager module and media communication module of FIG. 1 are shown in greater detail.

FIG. 3 is a flow diagram depicting a procedure in an example implementation in which media is optimized for different classes of computing device and made available via a single purchase.

FIG. 4 is a flow diagram depicting a procedure in an example implementation in which an item of media is purchased via a single transaction which grants access to the item of media in a variety of different forms.

FIG. 5 is a flow diagram depicting a procedure in an example implementation in which a listing is provided to other computing devices used to access a media provider to gain access to media purchased through a user account.

FIG. 6 illustrates various components of an example device that can be implemented as any type of portable and/or computer device as described with reference to FIGS. 1 and 2 to implement embodiments of the media purchase techniques described herein.

### DETAILED DESCRIPTION

### Overview

There is a vast amount of media functionality available to users of computing devices. Traditional techniques that were developed to interact with the media were often device centric, however. Accordingly, the user may interact with different subsets of an overall media collection using different devices, which may be frustrating to the user and result in a diminished overall user experience.

Media purchase techniques are described. In implementations, a media provider offers an item of media that may be purchased by a user and played on different classes of computing devices. Additionally, the media may be optimized for the different classes. For example, a user may purchase a video using a wireless phone. The user may then watch the video on the wireless phone and/or another class of computing device, such as a computer at the user's office or a television at the user's home. Additionally, the media item may be provided to these other classes of devices in a manner that is optimized for the device, such as having a resolution (both video and audio) that is optimized for a television experience as opposed to a mobile experience. A variety of other capabilities may also be optimized, such as synchronization, playback techniques, streaming techniques, and so on. Further, techniques are also contemplated that expose content purchased on one device for consumption on other devices.

In this way, a user may interact with a media collection using a variety of different devices and in a manner that is seamless between the devices, further discussion of which may be found in relation to the following figures. Thus, the techniques described herein may provide a seamless display of a user's content across a plurality of devices used by the user and may provide quick playback of media by providing a transition to a local copy via download. The techniques may also provide immediate access to purchased media as new devices and new device classes are used.

In the following discussion, an example computing device is described that may receive media from a media provider. However, it should be readily apparent that the following discussion is not to be limited to the example computing device and therefore a wide variety of computing devices and environments are contemplated. Thus, a variety of different devices may employ the techniques described herein without departing from the spirit and scope thereof, such as other computers such as desktop PCs, netbooks, wireless phones, personal digital assistants, and so on.

### Example Environment

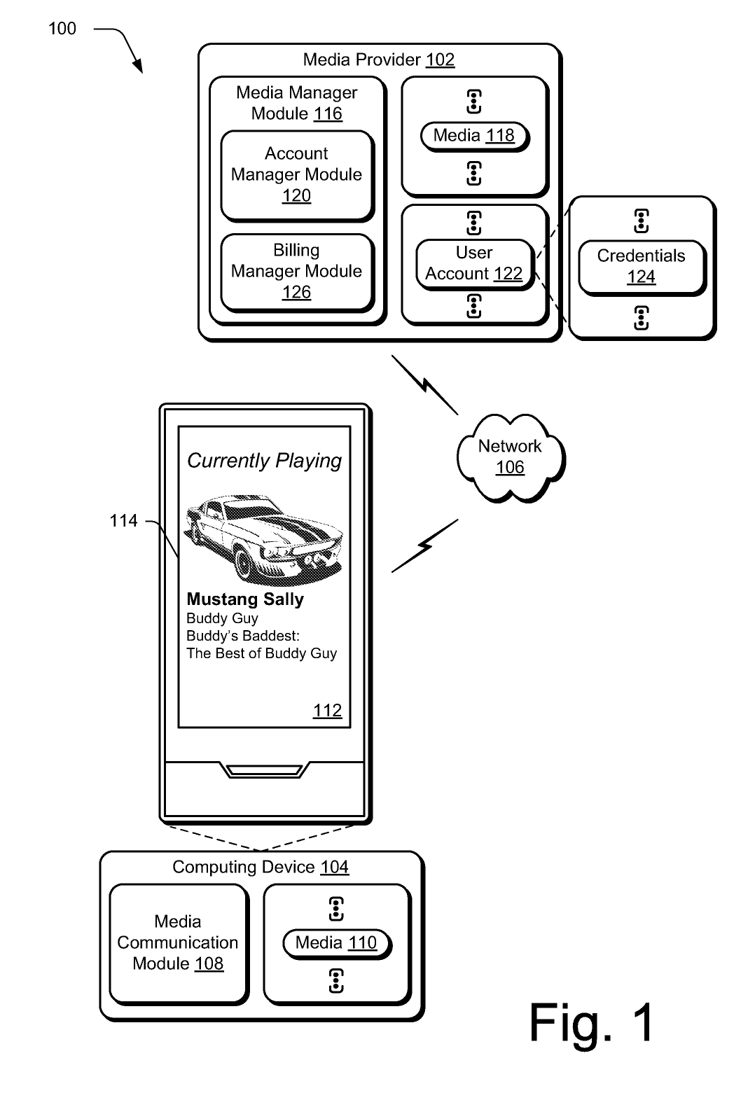

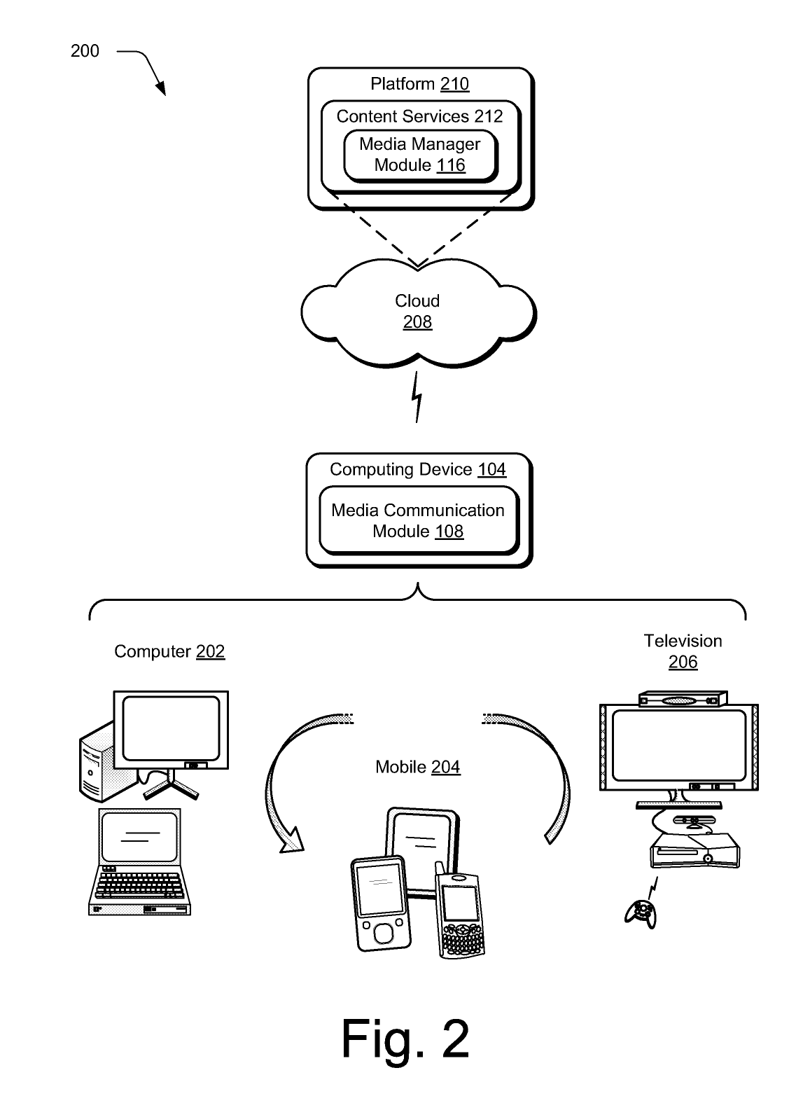

FIG. 1 is an illustration of an environment 100 in an example implementation that is operable to employ media techniques described herein. The illustrated environment 100 includes a media provider 102 that is communicatively coupled to a computing device 104 via a network 106. The computing device 104 is but one example of a computing device that may be configured in a variety of ways, further discussion of which may be found in relation to a discussion of classes of computing devices of FIG. 2.

The computing device 104 is illustrated as including a media communication module 108 which is representative of functionality relating to media consumption by the computing device 104. For example, the media communication module 108 of the media device 104 may include communication functionality to receive media via the network 106 from the media provider 102 and store it as media 110. The media 110 may also be obtained in a variety of other ways, such as via a local connection with another computing device (e.g., wired connection with a desktop PC to “rip” music, another mobile media device via a wireless connection, and so on).

The illustrated media communication module 108 may also be representative of functionality of the computing device 104 to generate and maintain a user interface 112 for display on a display device 114 of the computing device 104. The user interface 112 may be configured in a variety of ways, such as to display media that is currently being played by the computing device 104 using functionality of the media communication module 108.

The media provider 102 is illustrated as including a media manager module 116 that is representative of functionality to manage provision of and interaction with media. For example, the media manager module 116 may be configured to stream media 118 over the network 106 to the computing device 104 for immediate output and/or storage locally as media 110. The media manager module 116 may also be representative of functionality to control output of the media 110 locally by the computing device 104. The media manager module 116, for instance, may manage permissions of the computing device 104 to output the media 110 stored locally at the computing device 104 as well as media obtained elsewhere, such as media 118 from the media provider 102, media from a third-party entity, and so on. Thus, the media manager module 116 may employ a variety of different techniques to manage media usage by the computing device 104.

The media manager module 116 is also illustrated as including an account manager module 120 that is representative of functionality of the media provider 102 to manage a user account 122. The user, for instance, may interact with the media provider 102 via the network 106 using the computing device 104 to select media 118 for purchase. To purchase the media 118, the user may supply credentials 124 associated with a user account 122 (e.g., a user name and password) such that the billing manager module 126 may complete the transaction using billing information that is also associated with the user account 122.

As previously described, however, a user may interact with a variety of different types of computing devices in a typical day. Previous techniques that were developed to provide media 118 to users, however, were often device centric and therefore limited interaction with the type of computing device 104 that was used to purchase the media 118, and oftentimes even that particular computing device 104 itself. Accordingly, these traditional techniques often resulted in a fractured user experience that decreased the usefulness of the media and the computing devices to the user.

In the illustrated environment 100, however, media 118 provided by the media provider 102 may be accessed using a variety of different devices of the user, even as new devices and new device classes are made available to the user. Further, the media 118 may be optimized for different classes of devices, such as for a computer class, a mobile class, or a television class as further described in relation to FIG. 2.

For example, a single offer of an item of media 118 provided by the media provider 102 may include rights to consume the media 118 by a variety of different classes of devices. This allows the user to access the media 118 using multiple different classes of computing devices 102 from a single purchase of the media 118.

The media manager module 116, in an implementation, groups different encoded packages of the media 118 and maps which rights are permitted by the user to access the media, e.g., as a consequence of studio negotiated deals. The media provider 102 may then offer this media 118 for purchase via the network 106, e.g., to the computing device 104.

After a purchase of the media 118 by a user of the computing device 102, the media provider 102 may then provide the ability to access the media 118 using a variety of different devices. The media provider 102, for example, may then call into a catalog to access information relating to purchases associated with the user account 122 and thus verify whether the user account 122 has the associated rights to consume the media 118. Additionally, the media manager module 116 may perform digital rights management (DRM) to determine if this consumption is permitted by different classes of devices and/or how this consumption is permitted to occur.

The rights mapped to the offer, for instance, may permit the computing device 104 of the user to download the media 118 to local storage, stream the media such that it is rendered as received, and so on. Additionally, the local storage that is used to save the media may be included on the original computing device 104 that was used to complete the purchase and/or another computing device 104. Combinations of these examples are also contemplated, such as to both stream and save the media 118 to local storage such that the media 118 may be played back from a pause event even if a network connection is lost.

In addition, the media 118 may be optimized (e.g., at the point of ingestion) for different classes of computing devices 104 that may consume the media 118. For example, a television class of computing device (e.g., a game console) may receive a 1080p version of a video, whereas a computer class of computing device 104 may receive a 720p version of the video and a mobile class of computing device 102 may receive a version having even further reduced definition and/or size. In addition to the quality, variations of license rights can be mapped via digital rights management (DRM) to enforce protection of the media 118 to each class of device and/or the device itself. A variety of other capabilities may also be optimized, such as synchronization, playback techniques, streaming techniques, and so on.

In implementations, a file may be stored locally on the computing device 104 and/or remotely on the media provider 102 that provides a listing of media 118 that may be accessed by a user of the computing device 104. For example, the listing may be leveraged by the computing device 104 to automatically download permitted media 118 from the media provider 102. Thus, in this example the computing device 104 of the user may receive the media 118 automatically and without further user intervention upon logging in to the media provider 102, which may also be performed automatically. This listing may also “roam” between devices, such as when a user purchases a new computing device 104 to automatically update the new computer with the relevant media 118.

Yet further, the media manager module 116 may employ techniques to expose purchased media across a variety of devices used by a user associated with the user account 122. For example, a purchase history may be output to a user upon logging into a computing device 104 that summarizes purchases made by the user using the variety of different computing devices 104 previously described. Additionally, when a user chooses to interact with a particular item of media from the history, the item may be provided to the computing device in a form that is optimized for the particular class of device being used to access the media 118. Further discussion of access to media 118 by different classes of computing devices 104 may be found in relation to the following figure.

FIG. 2 illustrates an example system 200 that includes the computing device 102 as described with reference to FIG. 1. The example system 200 enables ubiquitous environments for a seamless user experience when running applications on a personal computer (PC), a television device, and/or a mobile device. Services and applications may appear to run substantially similar in each of these environments for a common user experience when transitioning from one device to the next while utilizing an application, playing a video game, watching a video, and so on.

In the example system 200, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 104 may assume a variety of different configurations, such as for computer 202, mobile 204, and television 206 uses. Each of these configurations includes devices that may have generally different constructs and capabilities, and thus the computing device 102 may be configured according to one or more of the different device classes. For instance, the computing device 102 may be implemented as the computer 202 class of a device that includes a personal computer, desktop computer, a multi-screen computer, laptop computer, netbook, and so on.

The computing device 102 may also be implemented as the mobile 202 class of device that includes mobile devices, such as a mobile phone, portable music player, portable gaming device, a tablet computer, a multi-screen computer, and so on. The computing device 102 may also be implemented as the television 206 class of device that includes devices having or connected to generally larger screens in casual viewing environments. These devices include televisions, set-top boxes, gaming consoles, and so on. The media techniques described herein may be supported by these various configurations of the computing device 104 and are not limited to the specific examples of the media techniques described herein.

The cloud 208 includes and/or is representative of a platform 210 for content services 212. The platform 210 abstracts underlying functionality of hardware (e.g., servers) and software resources of the cloud 208. The content services 212 may include applications and/or data that can be utilized while computer processing is executed on servers that are remote from the computing device 104. Content services 212 can be provided as a service over the Internet and/or through a subscriber network, such as a cellular or Wi-Fi network.

The platform 210 may abstract resources and functions to connect the computing device 102 with other computing devices. The platform 210 may also serve to abstract scaling of resources to provide a corresponding level of scale to encountered demand for the content services 212 that are implemented via the platform 210. For example, the content services 212 may support the media manager module 116 techniques described previously in relation to FIG. 1. Additionally, the techniques previously described for the media communication module 108 may be implemented by the computing device 104 when configured accordingly to one or more of the classes, e.g., computer 202, mobile 204, and television. Accordingly, in an interconnected device embodiment, implementation of functionality of the media manager module 116 and the media communication module 108 may be distributed throughout the system 200. For example, the media manager module 116 and/or the media communication module 108 may be implemented in part on the computing device 102 as well as via the platform 210 that abstracts the functionality of the cloud 208.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the media techniques described below are platform-independent, meaning that the techniques may be implemented on a variety of commercial computing platforms having a variety of processors.

### Example Procedures

The following discussion describes media purchase techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

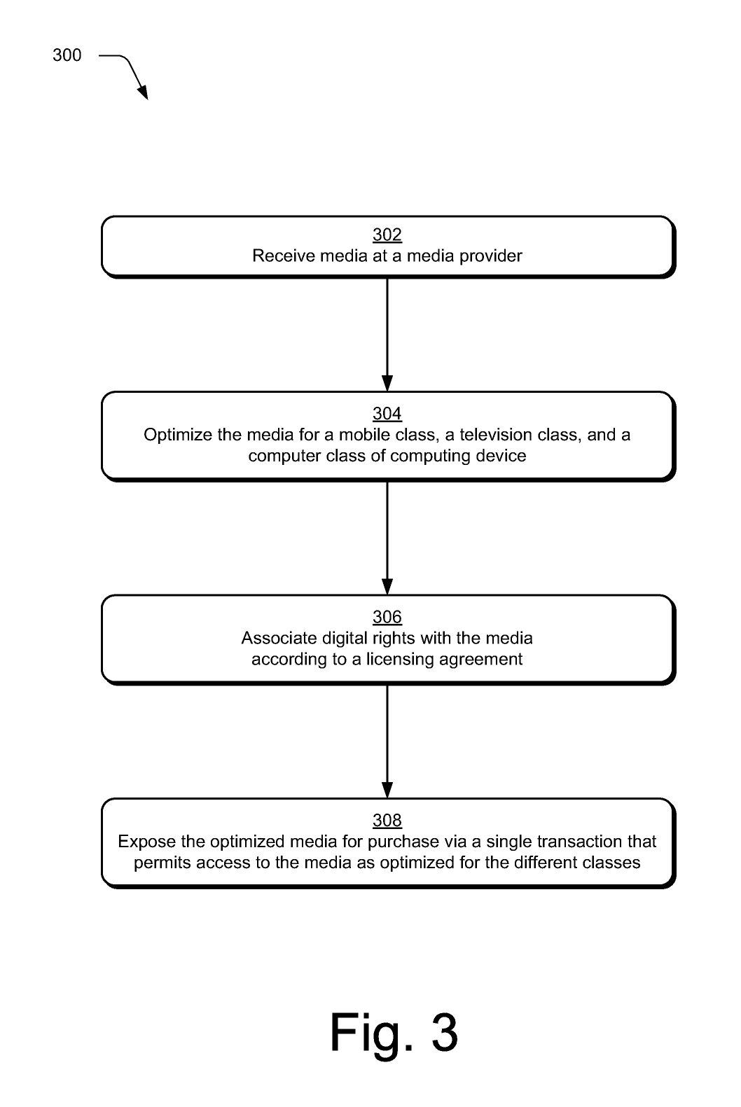

FIG. 3 depicts a procedure 300 in an example implementation in which media is optimized for different classes of computing device and made available via a single purchase. Media is received at a media provider (block 302). For example, the media may be received from a creator of the media, such as a movie studio, music studio, television studio, book publisher, and so on.

The media is optimized for a mobile class, a television class, and a computer class of computing device (block 304). The media, for instance, may be configured to have different resolutions for display devices utilized in the different classes, be configured to an amount of storage available in the different classes, and so on. The media may also be optimized for a variety of other capabilities, such as synchronization capabilities, streaming capabilities, playback capabilities, and so forth.

Digital rights are associated with the media according to a licensing agreement (block 306). For example, the media provider 102 may make a licensing agreement with a creator of the media regarding a cost to permit access to the media, how the media may be consumed (e.g., a time period, specific classes of device), and so forth. These rights may be captured using digital rights management to control how the media is consumed.

The optimized media is then exposed for purchase via a single transaction that permits access to the media as optimized for the different classes (block 308). Continuing with the previous example, the single purchase may permit a user to access the media using a mobile class of device and have the media provided to that device in a manner optimized for the mobile class, e.g., having a resolution and a storage size for the device. Likewise, the user may access the media from this single purchase using a computer class or television class of device. In this way, the media may be bought once and played back on a variety of devices that are configured to communicate with the media provider 102, further discussion of which may be found in relation to the following figure.

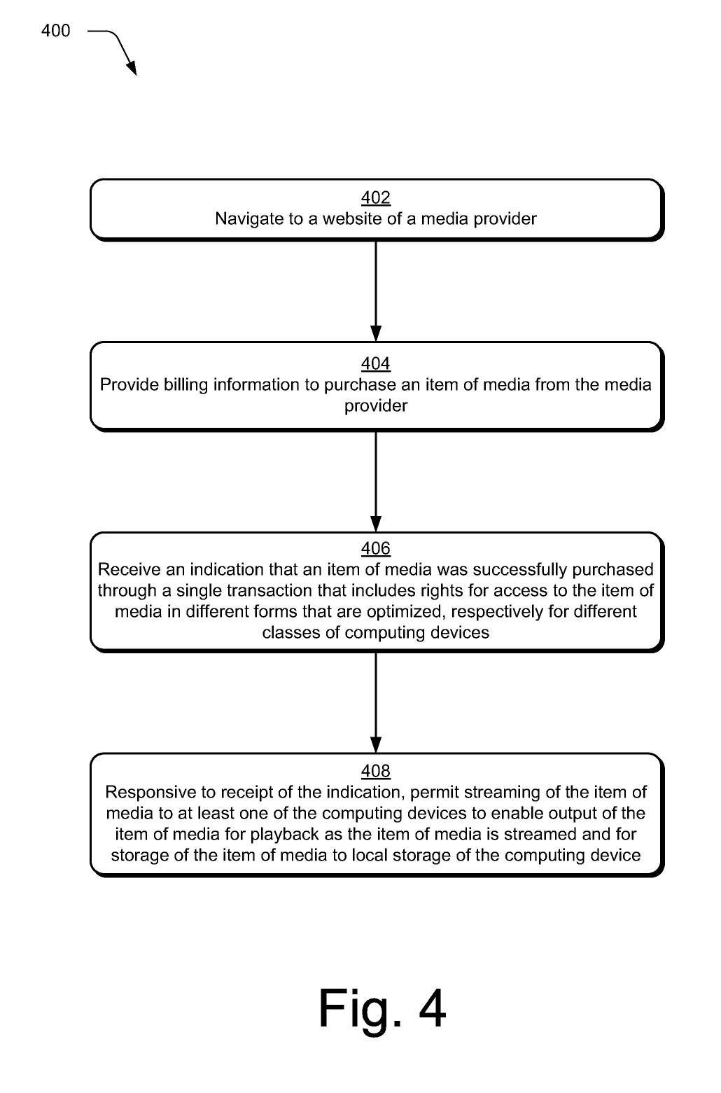

FIG. 4 depicts a procedure 400 in an example implementation in which an item of media is purchased via a single transaction which grants access to the item of media in a variety of different forms. A user of a computing device navigates to a website of a media provider (block 402), such as by using a browser of the computing device 104 to access the media provider 102 via the network 106.

Billing information is provided to purchase an item of media from the media provider (block 404). For example, the billing information may be provided manually by a user of the computing device 104, automatically through information stored locally on the computing device 104, and or initiated by the computing device 104 to permit provision of the information stored at the media provider 104, itself.

An indication is received that an item of media was successfully purchased through a single transaction that includes rights for access to the item of media in different forms that are optimized, respectively, for different classes of computing devices (block 406). Continuing with the previous example, the media may be optimized for mobile, computer, and television classes of computing devices.

Responsive to receipt of the indication, streaming of the item of media is permitted to at least one of the computing devices to enable output of the item of media for playback as the item of media is streamed and for storage of the item of media to local storage of the computing device (block 408). Thus, in this way, the item of media may be output as it is stored on the computing device 104. Further, should the streaming be interrupted, the media communication module 108 may switch from the stream to the locally stored copy, if available. Thus, in this example the item of media is output by the device that purchased it. The item of media may also be output by other devices that may access the user account 122 of the media provider 102, further discussion of which may be found in relation to the following figure.

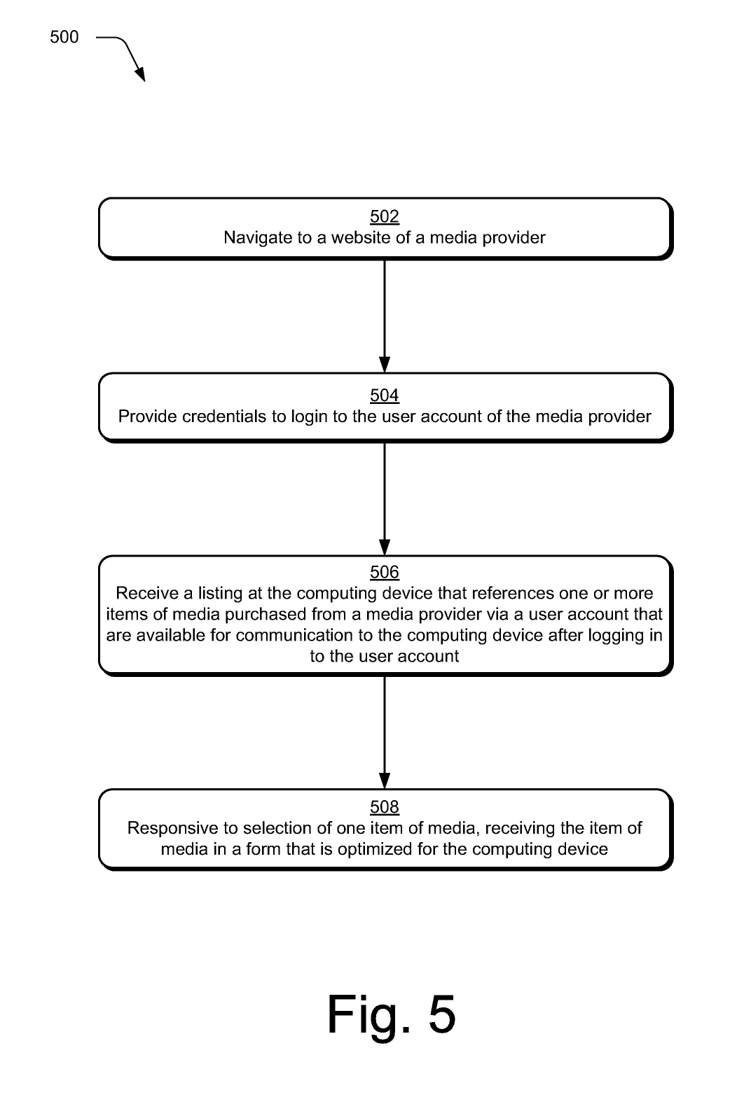

FIG. 5 depicts a procedure 500 in an example implementation in which a listing is provided to other computing devices used to access a media provider to gain access to media purchased through a user account. As before, a user interacts with a computing device to navigate to a website of a media provider (block 502). Credentials are provided to login to the user account of the media provider (block 504). However, in this example the computing device is different than a computing device used by the user in the example described in relation to FIG. 4. Additionally, in this example a different class of computing device may be used, such as mobile, computer, or television class of device that is different than the class used in FIG. 4.

A listing is received at the computing device that references one or more items of media purchased from a media provider via a user account that are available for communication to the computing device after logging in to the user account (block 506). The list, for example, may be configured to reference media items that are not already stored locally on the computing device 104 and/or are available for streaming to the computing device 104. In this way, a seamless display of the user's media may be accessible across devices that are available to the user. Further, the listing may be leveraged to automatically update (e.g., synchronize) media stored locally on the computing device, which may be performed responsive to one or more configuration settings and/or based on digital rights management considerations associated with the item of media.

Responsive to selection of an item of media, the item of media is received in a form that is optimized for the computing device (block 508). For example, an indication may be communicated to the media provider 102 that describes a class of a computing device that is to consume the media. The media provider 102 may then transmit the item of media to the computing device in a form that is optimized for that class. Other capabilities may also be optimized by the media provider 102, such as synchronization, playback, and streaming capabilities.

### Example Device

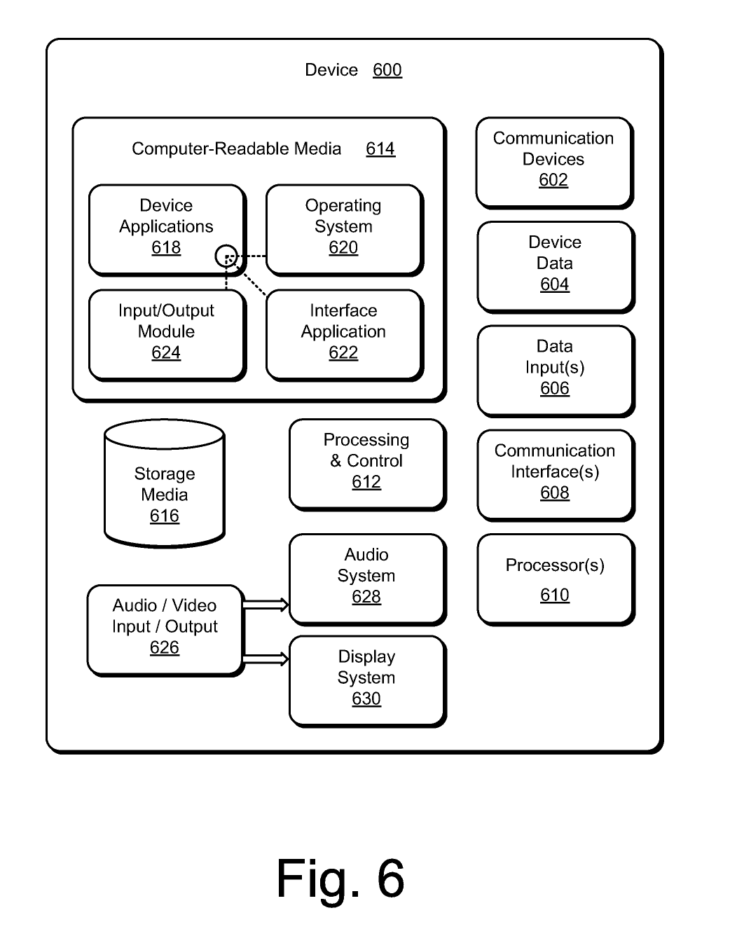

FIG. 6 illustrates various components of an example device 600 that can be implemented as any type of portable and/or computer device as described with reference to FIGS. 1 and 2 to implement embodiments of the media purchase techniques described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of techniques described herein. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.). The device applications 618 also include any system components or modules to implement embodiments of the media purchase techniques described herein. In this example, the device applications 618 include an interface application 622 and an input/output module 624 (which may be the same or different as input/output module 114) that are shown as software modules and/or computer applications. The input/output module 624 is representative of software that is used to provide an interface with a device configured to capture inputs, such as a touchscreen, track pad, camera, microphone, and so on. Alternatively or in addition, the interface application 622 and the input/output module 624 can be implemented as hardware, software, firmware, or any combination thereof. Additionally, the input/output module 624 may be configured to support multiple input devices, such as separate devices to capture visual and audio inputs, respectively.

Device 600 also includes an audio and/or video input-output system 626 that provides audio data to an audio system 628 and/or provides video data to a display system 660. The audio system 628 and/or the display system 660 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 660 are implemented as external components to device 600. Alternatively, the audio system 628 and/or the display system 660 are implemented as integrated components of example device 600.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
receiving a listing at the computing device that references one or more items of media purchased from a media provider via a user account that are available for communication to the computing device after logging in to the user account; and
responsive to selection of at least one said item of media, receiving the at least one said item of media in a form that is optimized for the computing device.

2. A method as described in claim 1, wherein:
the at least one said item of media was purchased through a single transaction that granted rights for access using different classes of computing devices; and
the at least one said item of media that is received at the computing device is optimized for a respective said class of the computing device by the media provider.

3. A method as described in claim 2, wherein the classes include a mobile class, a television class, and a computer class.

4. A method as described in claim 1, wherein the receiving is configured to permit:
output of the item of media for playback as the item of media is streamed; and
storage of the item of media to local storage of the computing device.

5. A method as described in claim 1, wherein the receiving is authorized based on a successful login to the user account without specifically authorizing the computing device to receive the media.

6. A method as described in claim 1, wherein the without specifically authorizing the computing device to receive the media includes receiving the at least one said item of media from the media provider without having the media provider associate an identifier of the computing device with the user account.

7. A method as described in claim 1, wherein the at least one said item of media is optimized for display capabilities of the computing device or storage capabilities of the computing device.

8. A method as described in claim 1, wherein the at least one said item of media is optimized for playback capabilities of the computing device, streaming capabilities to the computing device, or synchronization capabilities of the computing device.

9. A method as described in claim 1, wherein credentials are provided to login to the media provider by the computing device automatically and without user intervention.

10. A method as described in claim 1, wherein the receiving of the listing and the selection of the at least one said item of media are performed automatically and without user intervention by the computing device.

11. A method comprising:
receiving an indication that an item of media was successfully purchased through a single transaction that includes rights for access to the item of media in different forms that are optimized, respectively, for different classes of computing devices; and
responsive to the receipt of the indication, permitting streaming of the item of media to at least one said computing device to enable:
output of the item of media for playback as the item of media is streamed; and
storage of the item of media to local storage of the at least one said computing device.

12. A method as described in claim 11, wherein the single purchase involves a single price of the item of media to permit access to the item of media configured according to the computer, mobile, and television classes of computing devices.

13. A method as described in claim 11, further comprising transmitting a listing, for receipt by a computing device, that references one or more said items of media purchased from the media provider via a user account that are available for communication to the computing device after logging in to the user account.

14. A method as described in claim 11, wherein the item of media that is streamed to the at least one said computing device is optimized for the computing device.

15. A method as described in claim 14, wherein the item of media is optimized for display capabilities of the computing device or storage capabilities of the computing device.

16. A method as described in claim 14, wherein the item of media is optimized for playback capabilities of the computing device, streaming capabilities to the computing device, or synchronization capabilities of the computing device.

17. A method comprising:
offering an item of media for purchase via a network in which a single purchase of the item of media is configured to permit access to the item of media using a plurality of computing devices and permit access to the item of media as being optimized for a computer class, a mobile class, and a television class of computing device; and
providing access to the item of media as optimized responsive to verification of successive processing of purchase information to purchase the item of media.

18. A method as described in claim 17, wherein the item of media is optimized according to display capabilities or storage capabilities of a computing device that accesses a media provider that performs the offering and the providing of the access.

19. A method as described in claim 17, wherein the item of media is optimized for playback capabilities, streaming capabilities, or synchronization capabilities of a computing device that accesses a media provider that performs the offering and the providing of the access.

20. A method as described in claim 17, wherein the access to the item of media enables:
output of the item of media by a computing device for playback as the item of media is streamed; and
storage of the item of media to local storage of the computing device.
